(19) United States
(12) Patent Application Publication
(10) Pub. No.: US 2020/0117966 A1
(43) Pub. Date: Apr. 16, 2020

(54) WATER DELIVERY, TRACING AND MANAGEMENT SYSTEM THROUGH PLURAL WATER STATIONS

(71) Applicant: Kuang F Cheng, Taipei City (TW)

(72) Inventor: Kuang F Cheng, Taipei City (TW)

(21) Appl. No.: 16/158,285

(22) Filed: Oct. 11, 2018

(51) Int. Cl. G06K 19/06; G06Q 50/06; G01F 23/00

(52) U.S. Cl. CPC G06K 19/06; G06K 2017/0051; G01F 23/0061; G06Q 50/06

(57) ABSTRACT

A water delivery, tracing and management system through plural water stations includes a network system. The network system has a network center installed in a main server. The main server signally connected to a water plant end computer system of each water plant and the water station end computer system of each water station. The network center is connected to the relative applications with the water plant end computer system of each water plant and the water station end computer system of each water station so as to construct the whole network system. An outer side of each water bucket is attached with a label by reading which, messages about the water bucket are acquired. The water bucket is recycled; and the label of the water bucket is read for recording the data stored in the label.

### FIELD OF THE INVENTION

The present invention is related to delivery of water, and in particular to a water delivery, tracing and management system with a plurality of water stations.

### BACKGROUND OF THE INVENTION

In many communities, people need to buy drinking water of large quantity. Currently, water plants provide services for directly supplying water to various homes, offices, or plants. However, generally, water plants are far away from the water buyers, and thus it is often that a long distance for delivery of water is needed. Furthermore the water plants need to accumulate a large amount of orders for sending water tanks to the buyers. Therefore, the overall operations are not economic.

In areas having higher density of people delivery, water stations are installed in various locations. Water plants supply water to water stations, people can go to the water stations to draw water, but people need take longer time to take water by himself or herself. Generally, water is very heavy and it is a large burden for people and thus the quantity of water to be delivered is limited. This way is only suitable to people who needs a small quantity of water.

Furthermore, many houses and offices use water dispensers to supply drinkable water, in that water buckets are installed in water dispensers. If water in the water bucket exhausts, the water bucket is taken down from the water dispenser and another one is installed therein. However, by this way to provide drinkable water, a customer cannot know how much water is drunk, and how many water buckets have exhausted. Thus he or she does not know when to call the water provider to supply water buckets.

However, quantity of water drunk is very important to human health and it gets more and more attentions to people. Furthermore the water suppliers also need to know conditions of water buckets stored in various customers so the suppliers could determine an effective way for distributing water buckets to customers. Conventional ways for resolving above mentioned problems are based on the orders from the customers. Suppliers are passive to know the status of the water supply condition, but this is inefficient to the suppliers. Further, customers do not know how much water to be drunk and how many water buckets are left in the customers so that customers cannot have an effective way for managing water drunk and the number of water buckets.

Furthermore, in all the prior ways, the managers of the water supplier cannot know the conditions of each water bucket in sending, storage, and using states. Therefore the suppliers cannot make a precise control to all the water buckets, and thus they cannot effectively control the overall states in whole process, while this is important for the management of the water supply. As we know, electronic technologies are widely used in various fields, and thus the applicant of the present invention desires to develop a novel way which can effectively improve above mentioned prior art defect.

### SUMMARY OF THE INVENTION

Accordingly, the object of the present invention is to provide a water delivery, tracing and management system through plural water stations, wherein a network system is constructed to be connected to the water plant. The network system transfers all the data about the water bucket in various states to the water plant so that the water plant can supply water to the water station. In the present invention, labels are adhered to water bucket, such as QR code, bar codes, image identifiable images, or electronic cards, etc. The label can be read by the water bucket label reader, water station label reader, sender label reader, buyer label reader and water dispenser label reader to read the label and the read data is transferred to the network system. The water level and position of the water bucket are detected by the level detector and the position detector so that the states of the water bucket are known. Thereby, no matter in the sending process or recycle process, the states of the water buckets can be monitored so as to remind the system managers or the buyers. Thus the timing for supplying water can be precisely controlled.

To achieve above object, the present invention provides a water delivery, tracing and management system through plural water stations, comprising: a network system having: a network center installed in a main server; the main server signally connected to a water plant end computer system of each water plant and the water station end computer system of each water station; the network center being connected to the relative applications with the water plant end computer system of each water plant and the water station end computer system of each water station so as to construct the whole network system. An outer side of each water bucket is attached with a label by reading which, messages about the water bucket are acquired, Furthermore, the water bucket is recycled; and the label of the water bucket is read for recording the data stored in the label.

### BRIEF DESCRIPTION OF THE DRAWINGS

FIG. 1 is a schematic view about the system of the present invention.

FIG. 2 is a structural block diagram about the network system of the present invention.

FIG. 3 is an element block diagram of the present invention.

FIG. 4 is a schematic view showing the water dispenser of the present invention.

FIG. 5 is a schematic view showing that a handset is used to read data for realizing a sender label reader.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

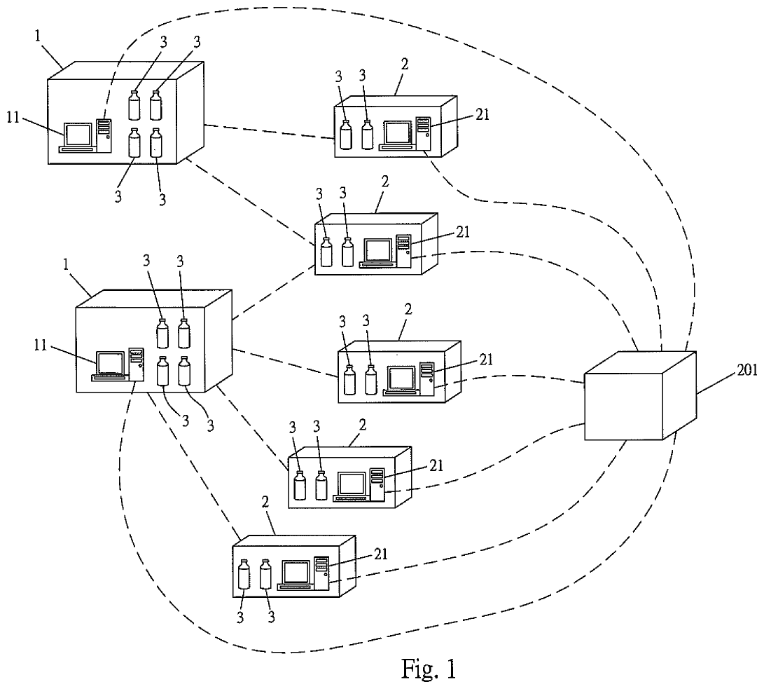

With reference to FIG. 1, a schematic view showing the structure of the present invention is illustrated. A practical system includes a plurality of water plants 2 for making water with determined specifications and distributing the water into different water buckets 3. Similarly the water buckets 3 are transferred to a plurality of water stations 2. When the water buckets 3 of a water station 2 is insufficient 2, the water plant 1 will supply the water buckets 3 to the water station 2. Preferably, the volume of each water bucket 3 is greater than 3 gallons. The system of the present invention includes the following elements.

A network system 200 has the following elements.

A network center 250 is installed in the server 201.

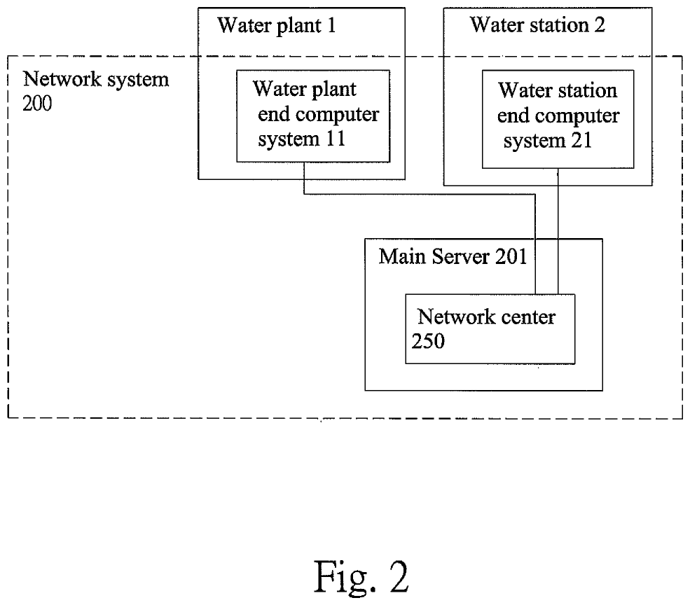

The main server 201 is signally connected to a water plant end computer system 11 of each water plant 1 and the water station end computer system 21 of each water station 2. The network center 250 is connected to the relative applications with the water plant end computer system 11 of each water plant 1 and the water station end computer system 21 of each water station 2 so as to construct the whole network system 200, as illustrated in FIG. 2.

In the following embodiments and the drawings, different function elements in the network system 200 are arranged on the positions showing in the drawings, but the arrangements of these elements are not confined to the positions showing in the drawings, those can be arranged on different locations of the network system 200 if these arrangements could achieve identical functions showing in the embodiments. These are well known in the art and thus all these arrangements are within the scope of the present invention.

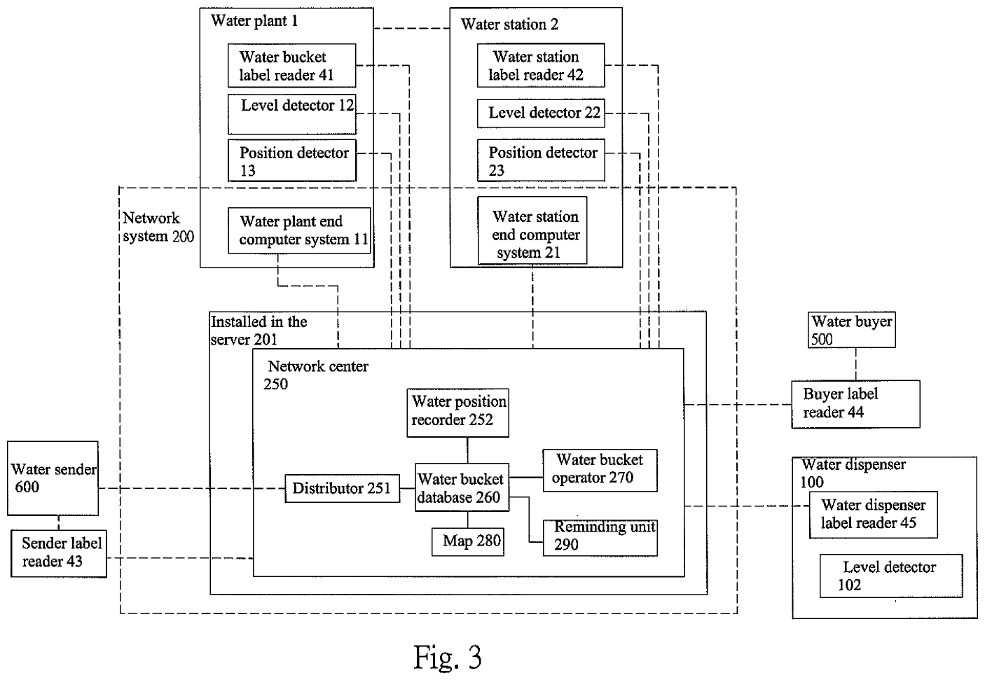

With reference to FIG. 3, the network system 200 includes a distributor 251 for designating a water sender 600 not hired by the owner of the network system 200 to send water buckets 3 to a buyer 500 after the water sender 600 is registered to and designated by the network system 200.

An outer side of each water bucket 3 is attached with a label 31 by reading which, messages about the water bucket 3 can be acquired. The label 31 may be any kinds of labels for identification of a water bucket 3, such as QR codes, bar codes, drawings capable of being identified electronically, any passive or active electronic devices, such as electronic cards, electronic strip. In the present invention, some of the codes of label for water buckets are different from each other.

A water bucket label reader 41 is signally connected to the network system 200 and is positioned in the water plant 1. The water bucket label reader 41 serves to read the label 31 on the water bucket 3 and recording the reading data from the label 31.

The water plant 1 is further installed with a level detector 12 for detecting water level of the water bucket 3 with a specific label 31. The water plant 1 is further installed with a position detector 13 for detecting the position of the water bucket 3. The position detector 13 may be any kind of known position detector, such as a GPS.

A water station label reader 42 is signally connected to the network system 200 and is installed in the water bucket 3. The water station label reader 42 serves to read the label 31 of the water bucket 3 and record reading data from the label 31 of the water bucket 3.

The water station 2 is further installed with a level detector 22 for detecting water level of a water bucket 3 with a specific label 31. The water station 2 is further arranged with a position detector 23 for recording position on the water bucket 3. The position detector 13 may be any kind of known position detector, such as a GPS.

A sender label reader 43 is signally connected to the network system 200 for reading the label 31 of the water bucket 3 and recording the read data. A sender label reader 43 arranged on a sender 600 designated by the network system 200 serves to read the label 31 of the water bucket 3 and transfers the read data to the network system 200. Thereby, the network system 200 may know the position of the water bucket 3. When the water bucket 3 is not in transferring, the network system 200 may know this state from the recording of the position of the water bucket 3. If necessary the sender 600 may know the water level by seeing.

When the sender 600 recycles the water bucket 3, positions of the water bucket 3 can be know by the sender label reader 43 to read the label 31 of the water bucket 3. When the water bucket 3 returns to the water plant 1, the water bucket label reader 41 may read the label 31 of the water bucket 3. Thereby, the network system 200 may read the traces of the water bucket 3 completely to have an optimum management.

A buyer label reader 44 is signally connected to the network system 200 for reading the label 31 of the water bucket 3 and recording the read data. When the water bucket 3 is sent to the buyer 500, the buyer label reader 44 serves to read the label 31 of the water bucket 3 and transfers the read data to the network system 200. Thereby, the network system 200 may know the position of the water bucket 3. If necessary the buyer 500 may know the water level by seeing.

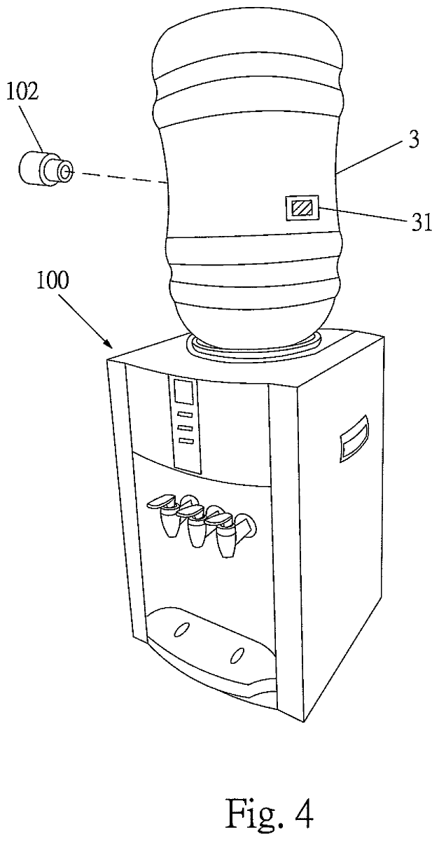

A water dispenser label reader 45 is signally connected to the network system 200 for reading the label 31 of the water bucket 3 and recording the read data as the water bucket 3 is installed on a water dispenser 100 (referring to FIG. 4). The water dispenser 100 includes a level detector 102 for detecting amount of water of the water bucket 3. The water dispenser 100 further includes the water dispenser label reader 45. When the water bucket 3 is taken down or installed to the water dispenser 100, the water dispenser label reader 45 reads the label 31 of the water bucket 3 so that the network system 200 may know whether the water bucket 3 is updated. Especially, when the water in the water bucket 3 is not fully exhausted, this state can be detected by the operation.

When the network system 200 receives data from any of the reader 41, 42, 43, 44 and 45, all the data from a specific label 31 of the water bucket 3 are recorded to a water bucket database 260.

The network system 200 further includes an water bucket operator 270 which is connected to the water bucket database 260 for operating the data in the water bucket database 260, the operations including to read the times of water filling to the water bucket 3 so as to determine the lifetime of the water bucket 3.

The operation of the water bucket operator 270 further includes to read an amount of water in the water bucket 3 so as to determine whether there is any water to leak out. It is determined from the data about amount of water of the water bucket 3 from the reader 41, 42, 43, 44 and 45.

The network system 200 further includes a water position recorder 252 for recording positions of the water buckets 3 and transfer these data about these positions to the water bucket database 260. These data are connected to a map 280. By clicking on the map 280, the water bucket 3 and data thererelated can be shown on the map 280. Managers of the network system 200 may view all these data, while other people only views the data related.

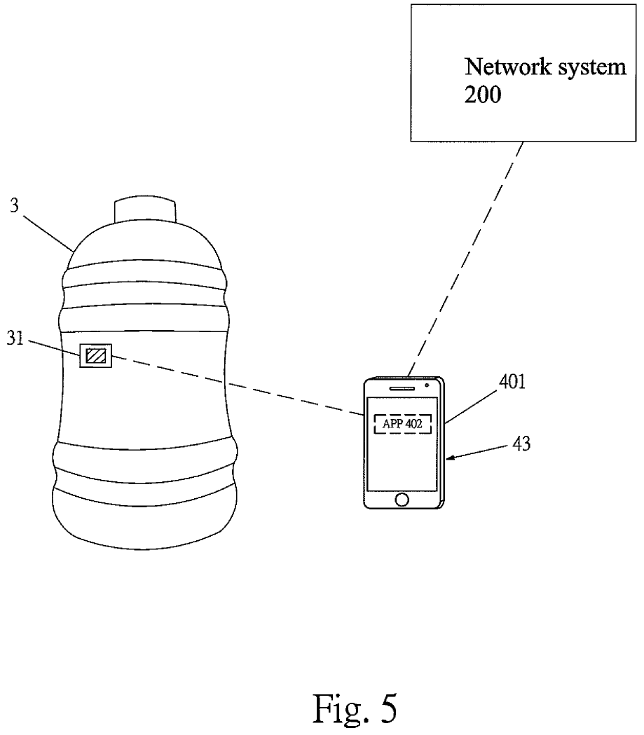

Preferably, the sender label reader 43 and the buyer label reader 44 use a handset 401 to read the label 31 and reading data is recorded in an APP of the handset 401 and then is uploaded to the network system 200. FIG. 5 shows the sender label reader 43 reads the label 31 of the water bucket 3 and uploads the data to the network system 200.

The network system 200 further includes a reminding unit 290 for reminding the people relative condition about the system, such as using times, leakage, position and others of the water bucket 3.

Advantages of the present invention are that a network system 200 is constructed to be connected to the water plant 1. The network system 200 transfers all the data about the water bucket 3 in various states to the water plant 1 so that the water plant 1 can supply water to the water station 2. The water buyer 500 enters into the network system 200 to buy water and the unspecific senders are determined by the network system 200 to send the water bucket 3 to the buyer 500. The buyer 500 is unnecessary to take the water bucket 3 to the water station 2. Therefore, the fees for transferring the water bucket 3 is saved.

In the present invention, labels 31 are adhered to the water bucket 3, such as QR code, bar codes, image identifiable images, or electronic cards, etc. The label 31 can be read by the water bucket label reader 41, water station label reader 42, sender label reader 43, buyer label reader 44 and water dispenser label reader 45 to read the label 31 and the read data is transferred to the network system 200. The water level and position of the water bucket 3 are detected by the level detector and the position detector so that the states of the water bucket 3 are known. Thereby, no matter in the sending process or recycle process, the states of the water buckets 3 can be monitored so as to remind the system managers or the buyers. Thus the timing for supplying water can be precisely controlled.

In the present invention, the sender 600 is not a specific contracted employee or a hired employee of the network system 200. Various senders may enter into the network system 200 and selected an electronic menu of a buyer which records the data about an order of the buyer. The network system 200 has no specific or hired employee to send water. Thereby, the water can be sent whole time and the cost is reduced greatly.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A water delivery, tracing and management system through plural water stations, comprising:
a network system having:
a network center installed in a main server; the main server signally connected to a water plant end computer system of each water plant and the water station end computer system of each water station; the network center being connected to the relative applications with the water plant end computer system of each water plant and the water station end computer system of each water station so as to construct the whole network system;
wherein an outer side of each water bucket is attached with a label by reading which, messages about the water bucket are acquired; and
wherein the water bucket is recycled; and each label has a code, and some of the codes of label for water buckets are different from each other.

2. The water delivery, tracing and management system through plural water stations as claimed in claim 1, wherein the system includes a plurality of water plants for making water with determined specifications and distributing the water into different water buckets; the water buckets are transferred to a plurality of water stations; when the water buckets of a water station is insufficient; the water plant supplies the water buckets to the water station; and
the network system includes a distributor for designating a water sender not hired by the owner of the network system to send water buckets to a buyer after the water sender is registered to and designated by the network system.

3. The water delivery, tracing and management system through plural water stations as claimed in claim 2, wherein a water dispenser label reader is signally connected to the network system for reading the label of the water bucket and recording the read data as the water bucket is installed on a water dispenser.

4. The water delivery, tracing and management system through plural water stations as claimed in claim 3, wherein the water dispenser includes a level detector for detecting amount of water of the water bucket; when the water bucket is taken down or installed to the water dispenser, the water dispenser label reader reads the label of the water bucket so that the network system knows whether the water bucket is updated.

5. The water delivery, tracing and management system through plural water stations as claimed in claim 4, wherein when the water in the water bucket is not fully exhausted, this state can be detected by the level detector and known by the network system.

6. The water delivery, tracing and management system through plural water stations as claimed in claim 1, wherein the label is selected from one of QR codes, bar codes, drawings capable of being identified electronically; passive or active electronic devices; electronic cards, and electronic recording strips.

7. The water delivery, tracing and management system through plural water stations as claimed in claim 2, wherein a water bucket label reader is signally connected to the network system and is positioned in the water plant; the water bucket label reader serves to read the label on the water bucket and recording reading data from the label.

8. The water delivery, tracing and management system through plural water stations as claimed in claim 2, wherein the water plant is further installed with a level detector for. detecting water level of the water bucket with a specific label; the water plant is further installed with a position detector for detecting the position of the water bucket.

9. The water delivery, tracing and management system through plural water stations as claimed in claim 2, wherein a water station label reader is signally connected to the network system and is installed in the water bucket; the water station label reader serves to read the label of the water bucket and record reading data from the label of the water bucket.

10. The water delivery, tracing and management system through plural water stations as claimed in claim 2, wherein the water station is further installed with a level detector for detecting water level of a water bucket with a specific label; the water station is further arranged with a position detector for recording position on the water bucket.

11. The water delivery, tracing and management system through plural water stations as claimed in claim 2, wherein a sender label reader is signally connected to the network system for reading the label of the water bucket and recording the read data; the sender label reader is arranged on a sender designated by the network system serves to read the label of the water bucket and transfers the read data to the network system; thereby, the network system knows the position of the water bucket; when the water bucket is not in transferring, the network system knows the state from the recording of the position of the water bucket.

12. The water delivery, tracing and management system through plural water stations as claimed in claim 11, wherein when the sender recycles the water bucket, positions of the water bucket is known by the sender label reader to read the label of the water bucket; when the water bucket returns to the water plant, the water bucket label reader reads the label of the water bucket; thereby, the network system reads the traces of the water bucket.

13. The water delivery, tracing and management system through plural water stations as claimed in claim 2, wherein a buyer label reader is signally connected to the network system for reading the label of the water bucket and recording the read data; when the water bucket is sent to the buyer, the buyer label reader serves to read the label of the water bucket and transfers the read data to the network system.

14. The water delivery, tracing and management system through plural water stations as claimed in claim 2, wherein when the network system receives data about a specific label of the water bucket, the data are recorded to a water bucket database.

15. The water delivery, tracing and management system through plural water stations as claimed in claim 14, wherein the network system further includes an water bucket operator which is connected to the water bucket database for operating the data in the water bucket database, the operations including to read the times of water filling to the water bucket so as to determine the lifetime of the water bucket.

16. The water delivery, tracing and management system through plural water stations as claimed in claim 15, wherein the water bucket operator reads an amount of water in the water bucket to determine whether there is any water to leak out.

17. The water delivery, tracing and management system through plural water stations as claimed in claim 1, wherein the network system further includes a water position recorder for recording positions of the water buckets and transfer these data about these positions to the water bucket database; and these data are connected to a map; by clicking on the map, the water bucket and data thererelated can be shown on the map.

18. The water delivery, tracing and management system through plural water stations as claimed in claim 13, wherein the buyer label reader uses a handset to read the label and reading data is recorded in an APP of the handset and then is uploaded to the network system.

19. The water delivery, tracing and management system through plural water stations as claimed in claim 11, wherein the sender label reader uses a handset to read the label and reading data is recorded in an APP of the handset and then is uploaded to the network system.

20. The water delivery, tracing and management system through plural water stations as claimed in claim 2, wherein the network system includes a reminding unit for reminding the people relative condition about the system.
